(19) United States
(12) Patent Application Publication
(10) Pub. No.: US 2015/0135084 A1
(43) Pub. Date: May 14, 2015

(54) CLOUD VISUALIZATION AND MANAGEMENT SYSTEMS AND METHODS

(71) Applicant: 2nd Watch, Inc., Liberty Lake, WA (US)

(72) Inventor: Joel ROSENBERGER, Sammamish, WA (US)

(21) Appl. No.: 14/538,555

(22) Filed: Nov. 11, 2014

Related U.S. Application Data
(60) Provisional application No. 61/903,274, filed on Nov. 12, 2013.

(51) Int. Cl. H04L 12/24; G06Q 30/04; G06F 3/0486; G06Q 10/06

(52) U.S. Cl. CPC H04L 41/50; G06Q 10/0631; G06Q 10/0637; G06Q 30/04; G06F 3/0486
USPC 715/738

(57) ABSTRACT

Cloud visualization and management systems and methods are described.

### CROSS-REFERENCE TO RELATED APPLICATIONS

This application claims the benefit of priority to Provisional Patent Application No. 61/903,274; filed Nov. 12, 2013 under Attorney Docket No. 2NDW-2013006; titled CLOUD VISUALIZATION SYSTEMS AND METHODS; and naming inventor Joel Rosenberger. The above-cited application is hereby incorporated by reference, in its entirety, for all purposes.

### FIELD

This disclosure is directed to the field of software, and more particularly to visualizing and managing an Infrastructure-as-a-Service (“IaaS”) platform.

### BACKGROUND

Cloud computing is having a profound impact on businesses and Amazon Web Services (“AWS”) has been particularly successful with hundreds of thousands of customers of all sizes across a diverse set of industries. But the deployment journey is complicated and fraught with inefficiency and challenges, and most companies lack the experience and tools to get up-and-running securely.

IT departments today lack integrated governance solutions that enable them to combat some of the issues preventing enterprises from moving to the cloud, including data breach risks, unauthorized access to networks and uncontrolled spending. Furthermore, IT professionals are being asked to deploy cloud infrastructures as quickly and cost effectively as possible. Yet most lack the in-house expertise to build and manage a cloud deployment, let alone do it fast and on budget. 2W Atlas stands apart as other existing solutions do not support a full suite of these capabilities, nor do they tightly integrate with the AWS platform, which leads to expensive customization projects or information that is not accurate.

The AWS “Elastic Beanstalk” automatically handles the deployment details of capacity provisioning, load balancing, auto-scaling, and application health monitoring.

However, Beanstalk should not be a concern for Enterprise customers for several reasons. For example, most clients who use Beanstalk are interested in uploading their application and running it and treating AWS resources as a black box that they do not control or manage. Further, Beanstalk does not provide multiple deployment ability, so it is better suited for basic test/applications than for Enterprise applications. Moreover, customers cannot control specific security, high availability, backup and disaster recovery, and performance related to Beanstalk—Amazon manages those requirements. In addition, reserved instances are not available, and many people view Beanstalk as a shared hosting environment.

### BRIEF DESCRIPTION OF THE DRAWINGS

FIG. 1 illustrates a simplified cloud visualization and management system in which cloud visualization and management device and client devices are connected to network.

FIG. 2 illustrates a visualization/management routine for visualizing and managing an Infrastructure-as-a-Service platform, such as may be performed by a cloud visualization and management device in accordance with one embodiment.

FIG. 3 illustrates a cloud-management routine for creating, managing, and budgeting worldwide applications in the cloud, such as may be performed by a cloud visualization and management device in accordance with one embodiment.

FIG. 4 illustrates several components of an exemplary cloud visualization and management device in accordance with one embodiment.

### DESCRIPTION

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

In various embodiments, a product such as 2W Atlas (provided by the assignee of the present application) may provide a visually-based solution for IT organizations to better leverage and manage the robust features of the AWS Cloud. 2W Atlas is a Software-as-a-Service (SaaS) application that is deeply integrated with the AWS platform, which enables IT professionals to quickly create, deploy and monitor cloud architectures. Well beyond providing efficiency advantages, 2W Atlas allows IT and finance professionals to tightly manage and allocate costs within an enterprise.

With 2W Atlas we are combining the ability to visualize and govern cloud architectures with the cost and monitoring capabilities needed to ensure the proper management once they are live. And in doing so, we are making the promise of the cloud accessible to an organization of any size.

2W Atlas designs, deploys and monitors the infrastructure while 2W Insight reports on it from billing and invoicing perspective. 2W Atlas has the ability to drill down into the reporting detail within 2W Insight since the two products are integrated together.

2W Atlas is a Software as a Service that runs on AWS (Amazon Web Services). The biggest benefit of 2W Atlas over AWS and other competitors is that it organizes and visualizes AWS resources and output data. This visualization makes it easy to see important events, alerts and information occurring in the Cloud—something that manual filtering and searches cannot deliver. 2W Atlas also handles the tagging on the backend for IT Operations versus having to do manual tagging. Without this automatic back end tagging based on Enterprises cloud architecture and deployment set up, tagging may end up being incomplete or complicated. And if tagging doesn't get done, the subsequent data and reporting will not be usable or accurate.

Q. What are the other things 2W Atlas does better than AWS alone? These may be better features when compared to other competitors as well.

AWS gives you access to all the data and information on the resources. However, you have to know what you are looking for and it is hard to know what to focus your attention on as an IT Professional. 2W Atlas gives you the ability to view and organize data by departments and deployments. Worldwide Enterprise IT resources, deployments, and Reserved Instances (RIs), among other things, are organized in a hierarchical layout so you can keep a pulse on the business based on the Regions or departments aligned to your specific needs—with the ability to probe further into cost & usage details as required.

AWS lets you create cloud architectures. However, with 2W Atlas, the ability to visualize the cloud architecture makes it easier to see whether the resources are connected properly. Example: Ability to tell whether a disaster recovery (DR) set up has been added and configured correctly in script form is harder to validate than visually seeing your backup and DR visually attached to a database.

AWS lets you leave the cloud architectures in an Simple Storage Service bucket. However, anyone with access to the management console can deploy and change those cloud architectures. With 2nd Watch, you drop cloud architectures into 2W Atlas to ensure restricted access DDD only authorized IT personnel have role-based access to change and deploy the cloud architectures.

AWS gives you the ability to upload new cloud architectures. 2W Atlas allows the same thing, but also provides updated projected costs estimates for running that deployment.

AWS gives you access to all of your deployments—but in raw data form. 2W Atlas lets you see multiple deployments on one screen with an intuitive navigation menu to allow you to go between deployments and view relevant info such as Events, Alerts, Storage/Compute costs, Output/Endpoint details, etc.

AWS allows alerts on only a few alarms from CloudWatch. 2W Atlas lets Enterprises set up events and alerts on any AWS event (API calls, start of new instances, change in security groups, and status changes).

Q. What are the benefits to the different users in an Enterprise?

2W Atlas provides IT operations with a way to upload cloud architectures to visualize the deployment, estimate costs, and monitor the Enterprise's AWS infrastructure in the cloud. IT Operations gain role-based access to the deployment and monitoring aspects of 2W Atlas so they can quickly react to business needs while maintaining IT Governance & compliance.

2W Atlas also provides IT Finance and business users with visibility into cloud costs early so they can proactively red flag cost allocations that will exceed Cloud budgets.

Provides business managers with high level views of Cloud IT costs and uptime to drive accountability throughout the organization.

Q. What can I do from 2W Atlas management console?

Upload cloud architectures to visualize deployments. Visually provision, configure, monitor and report on multiple deployments around the world.

Q. Can we test the rollout of the deployment before customer launches or updates their project to the environment?

Yes, 2W Atlas provides the client with ability to upload cloud architectures into 2W Atlas and visualize the deployment. This visualization makes it easier to find errors in the deployment and find places where resources are not connected as they should be. As the deployment changes, clients gets new cloud deployment cost estimates for better business planning.

Q. What is the recommended patch management process?

Currently, clients will need to use Chef and Puppet independently to handle patch management. 2W Atlas will integrate with Chef/Puppet in a future version by integrating with knives and recipes.

Currently however, this is how Chef and 2W Atlas work: The client installs Chef Server and Chef Clients on appropriate resources. Chef then manages these servers and clients via recipes and knives. Separately, 2W Atlas can deploy, monitor and report on these servers and client just as it would any other server. 2W Atlas reports how much the Chef Server and clients cost to use and run. In addition, 2W Atlas can be set up with events and alerts related to the server itself.

An Enterprise can use 2W Atlas to physically monitor databases and cost/usage related to database, but must use a third party app to get database specific alerts, disk space utilization, etc.

Q. How does 2nd Watch handle security management policies for employee access?

Because 2W Atlas (the application itself) is the only thing that has access to AWS, employees cannot access all of the AWS data under 2nd Watch management. Each Enterprise/customer has a different user name and password associated with their AWS account. 2nd Watch employees have access to the Enterprise accounts through restricted access from 2nd Watch's NOC in Spokane and a secure server that stores the metadata. The access to the application is role- and log-in-based—something that IT Operations sets up individually for appropriate 2nd Watch employees.

Q. Tell me more about 2W Atlas auditing features. Does 2W Atlas give me “the who, what and where” aspects of root level security?

Yes, 2W Atlas does give you visibility into the who, what and where aspects of root level security, but only for certain services (via Amazon Beta being announced in re:Invent). This auditing feature is currently only available on East and West coast of US. The only 4 services supported by the auditing feature are Elastic Compute Cloud, IAM, Simple Storage Service, RDS.

Example: If you start or change Simple Storage Service, Elastic Compute Cloud, or RDS, 2W Atlas will log it in a file and also bubble it up as an event or alert depending on the importance you assigned to it. If you did not have 2W Atlas, the new beta will log the change, but will not draw attention to it.

Q. How do I change or upload a new cloud architecture?

If someone updates a cloud architecture, they must upload the new or modified architecture in the 2W Atlas template. If the new cloud architecture is not uploaded to 2W Atlas (and simply stays in a folder somewhere), the old architecture will be used for compliance.

Also, the old cloud architecture that you are replacing is not saved in 2W Atlas since we currently do not track and save cloud architectures for future use and reference. Cloud architectures must be saved to a file and uploaded into 2W Atlas every time a change is implemented. Older cloud architectures need to be managed by Enterprise IT Operations currently.

Q. How does compliance work with cloud architecture changes and new updates?

2W Atlas audit logs track who modified or added a new cloud architecture as well as when.

With current auditing log beta, IT Operations would have the information in the log file, but they are not alerted to the change proactively.

The next version of 2W Atlas will have alerts for cloud architecture changes. Next version will also give IT Operations the ability to save multiple versions, as well provide a way to document what the changes were and why the changes were made to the cloud architecture for future use and reference.

Q. What tools were used to build 2W Atlas?

Javascript, MS .NET, HTML 5.0

Q. Can 2W Atlas gather and present all the endpoints for AWS.

Yes. Endpoints are known as the Outputs of cloud architecture . . . outputs such as user names, passwords, IP addresses, DNS names, URLs. All of these end points are needed for a client to stand up the infrastructure. With AWS currently, if you have several accounts, an admin is required to log into each individual account to get the outputs (end points) they need—one by one. With 2W Atlas, all of these endpoints are available in the Deployment->Details->Outputs section.

Problems with the way AWS presents output include the following.
You need to log in to Amazon Console (Amazon Console->Cloud Formation->Outputs)
The outputs are listed in an unfriendly way (i.e. 12 digit string) and the IT person needs to know what he/she is looking for
Outlier problems are hard to spot (i.e. if someone leaves company, it's hard to find the resource they are associated with to turn it off).

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

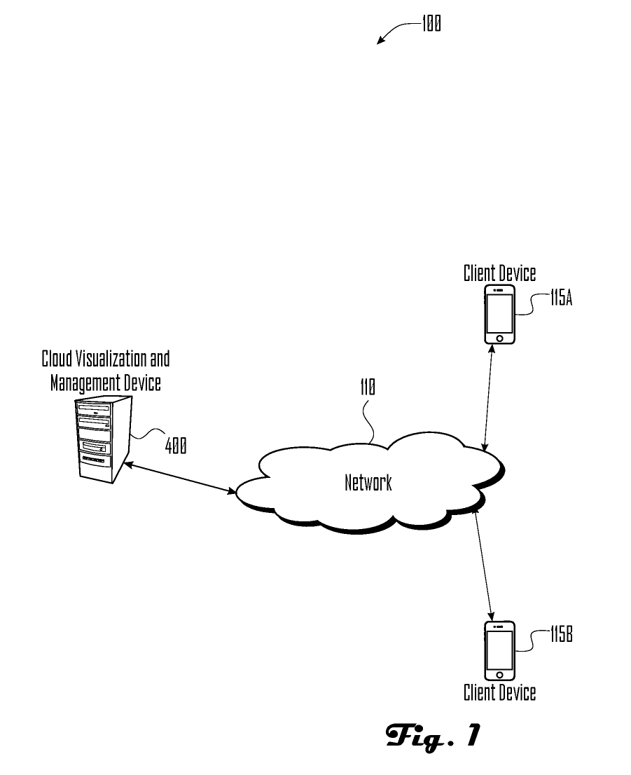

FIG. 1 illustrates a simplified cloud visualization and management system in which cloud visualization and management device 400 and client devices 115A-B are connected to network 110.

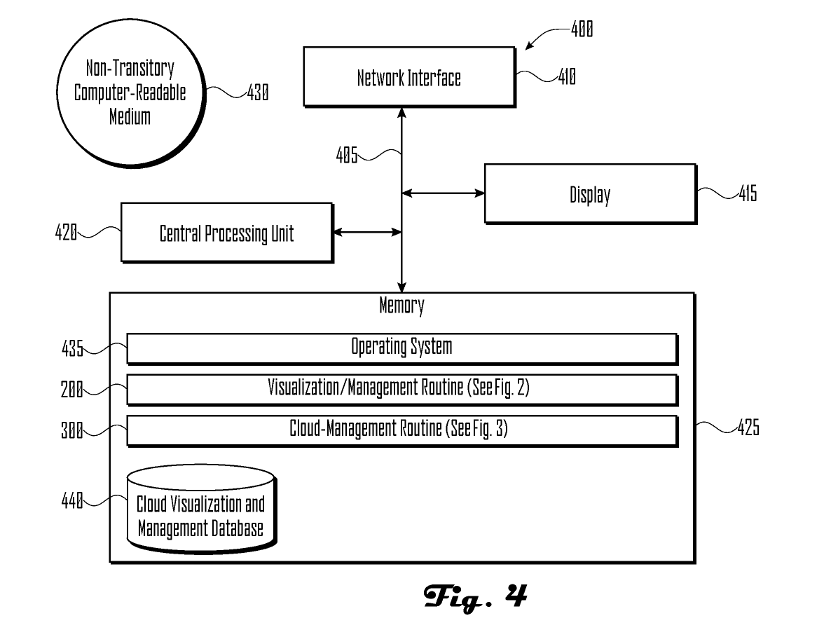

Cloud visualization and management device 400 (see FIG. 4, discussed below) represents a provider of cloud-visualization-and-management services, such as described more fully below.

In various embodiments, network 110 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like.

Client devices 115A-B represent one or more computing devices that are capable of connecting to network 110 and communicating with cloud visualization and management device 400, such as described herein.

In various embodiments, additional infrastructure (e.g., short message service centers, cell sites, routers, gateways, firewalls, and the like), as well as additional devices may be present. Further, in some embodiments, the functions described as being provided by some or all of cloud visualization and management device 400 may be implemented via various combinations of physical and/or logical devices.

However, it is not necessary to show such infrastructure and implementation details in FIG. 1 in order to describe an illustrative embodiment.

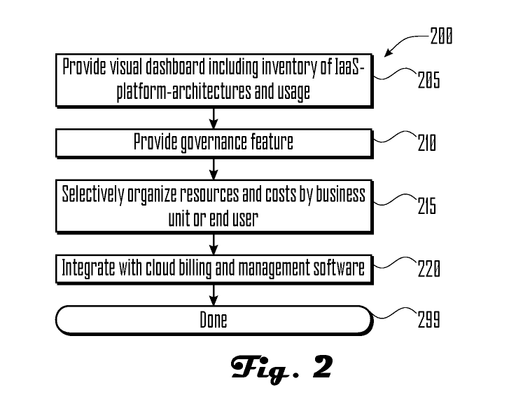

FIG. 2 illustrates a visualization/management routine 200 for visualizing and managing an Infrastructure-as-a-Service (“IaaS”) platform, such as may be performed by a cloud visualization and management device 400 in accordance with one embodiment.

In block 205, visualization/management routine 200 provides a visual dashboard. In some embodiments, the visual dashboard includes an inventory of deployed AWS cloud architectures and AWS usage for compute, networking, database and storage associated with each deployment. This eliminates the need for deep technical expertise, simplifies the management of enterprise scale deployments, ensures proper IT governance and provides audit capabilities of individual resources.

In block 210, visualization/management routine 200 provides a governance feature. In some embodiments, the governance feature may improve the security of cloud deployments. This includes an ability to provide visibility into what's been deployed and how; to pinpoint configuration challenges; to make changes instantly (instead of within weeks); and to quickly dig into cloud formation scripts to see if an architecture was changed.

In block 215, visualization/management routine 200 selectively organizes resources and costs by business unit, project, or end user. This ensures that cloud architectures are compliant with IT policies and standards, enables programmatic and repeatable deployments across the enterprise, and facilitates quicker and lower cost deployment of systems and platforms.

In block 220, visualization/management routine 200 integrates with cloud billing and management software, which simplifies the costing and management of AWS resources by providing running cost estimation prior to deployment, and delivers resource allocations and charge backs by project, business unit or user.

Visualization/management routine 200 ends in ending block 299.

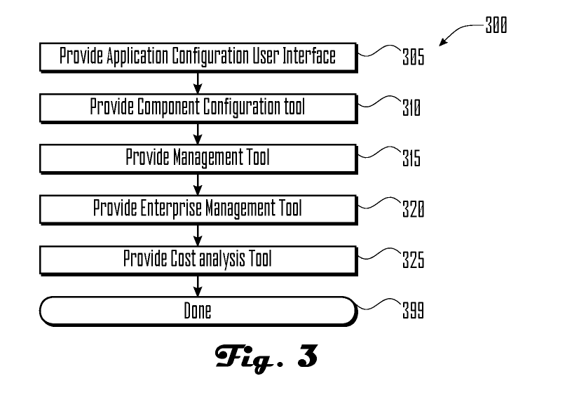

FIG. 3 illustrates a cloud-management routine 300 for creating, managing, and budgeting worldwide applications in the cloud, such as may be performed by a cloud visualization and management device 400 in accordance with one embodiment.

In various embodiments, cloud-management routine 300 may be performed as part of an Enterprise Cloud Management Platform that enables IT professionals to create, manage and budget worldwide applications in the cloud. By using templates, users can quickly configure multi-tier application environments around the world then deploy the environment within minutes.

Within such a platform, there are industry-leading monitoring tools to ensure your application platform is running efficiently and error-free. Plus combining our management platform with 2W Insight, your finance department will have unprecedented visibility into costs by project, department and region.

In block 305, cloud-management routine 300 provides an Application Configuration User Interface. In some embodiments, the UI allows the user to drag-and-drop pre-defined cloud components such as Elastic Compute Cloud instances, Load Balancing, Relational Database Service, etc . . . The components are configured via our component design tools that enables the author to set properties and define custom scripts to load specific applications or instance settings. The drag-n-drop surface consists of a multi-layer application stack (1st tier, 2d tier, 3d tier, etc . . . ). The tiers have custom properties and allow different components to be added plus compliance and security rules defined by your IT compliance team.

In block 310, cloud-management routine 300 provides a Component Configuration tool. In some embodiments, this tool provides fundamental components such as Elastic Compute Cloud instances, Simple Storage Service buckets, etc . . . A component author uses these fundamental building blocks to create components in a Cloud Formation script snippets. These snippets can then be added to a cloud formation template as part of a reference architecture. Part of this process is building common components within your organization that comply with all security and governance standards. The components are then made available for the Application Configuration tool.

In block 315, cloud-management routine 300 provides a Management Tool. In some embodiments, this tool provides the IT operator the ability to deploy and manage multiple application configurations or templates. Basically the tool will read the available templates then allowing the user to select a region plus a few other deployment settings. The invoking the cloud formation APIs the system will launch the application environment. In addition, the management tool provides visibility into the health and status of the system. For example, each tier is represented with a number of green, yellow and red instances (or cloud components). The system uses a combination of AWS status information (via APIs) plus additional application monitoring techniques such as Gomez, Machine Agents, etc . . . The IT operator than has a quick dashboard to the cloud application plus the ability to drill into a server group or even a single server (with the capability to log onto the server).

In block 320, cloud-management routine 300 provides a Enterprise Management Tool. In some embodiments, this tool provides an IT organization the ability to make cloud application groups and view those groups on a worldwide map. This map shows all of the worldwide AWS regions with high level status and load characteristics.

In block 325, cloud-management routine 300 provides a Cost analysis Tool. In some embodiments, this tool provides the IT team to quickly estimate an application configuration; and provide a business ready analysis report of the components costs (high/med/low) based on the configuration that complies with the corporate governance. In addition this tool provides the IT and Finance departments insight into the actually costs of running application systems. Using the 2W Insights platform, each application's usage is monitored, analyzed and optimized to give the highest performance at the lowest costs.

Cloud-management routine 300 ends in ending block 399.

FIG. 4 illustrates several components of an exemplary cloud visualization and management device in accordance with one embodiment. In various embodiments, cloud visualization and management device 400 may include a desktop PC, server, workstation, mobile phone, laptop, tablet, set-top box, appliance, or other computing device that is capable of performing operations such as those described herein. In some embodiments, cloud visualization and management device 400 may include many more components than those shown in FIG. 4. However, it is not necessary that all of these generally conventional components be shown in order to disclose an illustrative embodiment.

In various embodiments, cloud visualization and management device 400 may comprise one or more physical and/or logical devices that collectively provide the functionalities described herein. In some embodiments, cloud visualization and management device 400 may comprise one or more replicated and/or distributed physical or logical devices.

In some embodiments, cloud visualization and management device 400 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Cloud visualization and management device 400 includes a bus 405 interconnecting several components including a network interface 410, a display 415, a central processing unit 420, and a memory 425.

Memory 425 generally comprises a random access memory (“RAM”) and permanent non-transitory mass storage device, such as a hard disk drive or solid-state drive. Memory 425 stores program code for a visualization/management routine 200 for visualizing and managing an Infrastructure-as-a-Service (“IaaS”) platform (see FIG. 2, discussed above) and a cloud-management routine 300 for creating, managing, and budgeting worldwide applications in the cloud (see FIG. 3, discussed above). In addition, the memory 425 also stores an operating system 435.

These and other software components may be loaded into memory 425 of cloud visualization and management device 400 using a drive mechanism (not shown) associated with a non-transitory computer-readable medium 430, such as a floppy disc, tape, DVD/CD-ROM drive, memory card, or the like.

Memory 425 also includes cloud visualization and management database 440. In some embodiments, cloud visualization and management device 400 may communicate with cloud visualization and management database 440 via network interface 410, a storage area network (“SAN”), a high-speed serial bus, and/or via the other suitable communication technology.

In some embodiments, cloud visualization and management database 440 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Although specific embodiments have been illustrated and described herein, it will be appreciated by those of ordinary skill in the art that alternate and/or equivalent implementations may be substituted for the specific embodiments shown and described without departing from the scope of the present disclosure. In various embodiments, similar techniques may be applied to manage other Infrastructure-as-a-Service (“IaaS”) platforms. This application is intended to cover any adaptations or variations of the embodiments discussed herein.

1. A server-device-implemented method for visualizing and managing an Infrastructure-as-a-Service (“IaaS”) platform, the method comprising:
providing a visual dashboard including an inventory of IaaS-platform-architectures and usage for one or more of compute, networking, database, and storage associated with a deployment;
providing a governance feature for one or more of providing visibility into deployments, identifying configuration challenges, making changes, and inspecting cloud-formation scripts to determine whether an architecture was changed;
selectively organizing resources and costs by business unit, project, or end user; and
integrating with cloud billing and management software.

2. A computing apparatus for visualizing and managing an Infrastructure-as-a-Service (“IaaS”) platform, the apparatus comprising a processor and a memory storing instructions that, when executed by the processor, configure the apparatus to:
provide a visual dashboard including an inventory of IaaS-platform-architectures and usage for one or more of compute, networking, database, and storage associated with a deployment;
provide a governance feature for one or more of providing visibility into deployments, identifying configuration challenges, making changes, and inspecting cloud-formation scripts to determine whether an architecture was changed;
selectively organize resources and costs by business unit, project, or end user; and
integrate with cloud billing and management software.

3. A non-transitory computer-readable storage medium having stored thereon instructions including instructions that, when executed by a processor, configure the processor to:
provide a visual dashboard including an inventory of Infrastructure-as-a-Service-(“IaaS”) platform-architectures and usage for one or more of compute, networking, database, and storage associated with a deployment;
provide a governance feature for one or more of providing visibility into deployments, identifying configuration challenges, making changes, and inspecting cloud-formation scripts to determine whether an architecture was changed;
selectively organize resources and costs by business unit, project, or end user; and
integrate with cloud billing and management software.

4. A server-device-implemented method for creating, managing, and budgeting worldwide applications in the cloud, the method comprising:
providing an Application Configuration User Interface allowing the user to drag and drop pre-defined cloud components such as Elastic Compute Cloud instances, Load Balancing, and Relational Database Services;
providing a Component Configuration tool for configuring fundamental components such as Elastic Compute Cloud instances, and Simple Storage Service buckets;
providing a Management Tool enabling the user to deploy and manage multiple application configurations or templates;
providing a Enterprise Management Tool enabling the user to make cloud application groups and view those groups on a map; and
providing a Cost analysis Tool enabling the user to estimate an application configuration and provide a business-ready analysis report of the components costs based on the configuration that complies with corporate governance.

5. A computing apparatus for creating, managing, and budgeting worldwide applications in the cloud, the apparatus comprising a processor and a memory storing instructions that, when executed by the processor, configure the apparatus to:
provide an Application Configuration User Interface allowing the user to drag and drop pre-defined cloud components such as Elastic Compute Cloud instances, Load Balancing, and Relational Database Services;
provide a Component Configuration tool for configuring fundamental components such as Elastic Compute Cloud instances, and Simple Storage Service buckets;
provide a Management Tool enabling the user to deploy and manage multiple application configurations or templates;
provide a Enterprise Management Tool enabling the user to make cloud application groups and view those groups on a map; and
provide a Cost analysis Tool enabling the user to estimate an application configuration and provide a business-ready analysis report of the components costs based on the configuration that complies with corporate governance.

6. A non-transitory computer-readable storage medium having stored thereon instructions including instructions that, when executed by a processor, configure the processor to:
provide an Application Configuration User Interface allowing the user to drag and drop pre-defined cloud components such as Elastic Compute Cloud instances, Load Balancing, and Relational Database Services;
provide a Component Configuration tool for configuring fundamental components such as Elastic Compute Cloud instances, and Simple Storage Service buckets;
provide a Management Tool enabling the user to deploy and manage multiple application configurations or templates;
provide a Enterprise Management Tool enabling the user to make cloud application groups and view those groups on a map; and
provide a Cost analysis Tool enabling the user to estimate an application configuration and provide a business-ready analysis report of the components costs based on the configuration that complies with corporate governance.
